(19) United States
(12) Patent Application Publication
(10) Pub. No.: US 2004/0114363 A1
(43) Pub. Date: Jun. 17, 2004

(54) DC powered retrofit fluorescent lamp lighting for vehicular and non vehicular applications

(76) Inventor: Paul Crunk, Taylor, MI (US)

Correspondence Address: PAUL CRUNK, 12220 WOODCREST BOX 725, TAYLOR, MI, 48180, US

(21) Appl. No.: 10/321,180

(22) Filed: Dec. 17, 2002

(51) Int. Cl. F21V 23/02

(52) U.S. Cl. 362/222; 362/216

(57) ABSTRACT

A fluorescent lamp, a direct replacement of any size or shape of a standard incandescent lamp used inside or outside of any motorized vehicle like trucks, motor homes farm equipment or non motor vehicle applications like truck trailer, campers, recreational applications using the current mounting fixtures. The lamp can be made to fit existing or new vehicle or non-vehicle applications worldwide. The fluorescent lamp can contain a cut-off sensor circuit, regulated step up and step-down circuit allowing the lamp to be used in or on many types of D.C. voltage applications worldwide preventing the lamp circuit and fluorescent bulb from under power or over power thus providing better safety of the circuit, the fluorescent bulb and allowing all components of the lamp to have a much longer life.

### BACKGROUND OF INVENTION

At the present time fluorescent lighting is used in non-vehicle applications and some vehicle applications to illuminate the inside of semi trailers, motor homes and recreational vehicles are in shapes of a rectangle type of lamp without any regulated circuit or fluorescent bulb protection. To this present day there has never been fluorescent lamps made to be a direct replacement (retro-fit) for standard four-inch lamp, six inch, square, rectangle or oval shape or very small type incandescent like 2″, 3″ or maker lamp type incandescent bulb lighting to act as a retrofit fluorescent type of lamp to be used in the vehicular applications.

### BRIEF SUMMARY OF THE INVENTION

The present invention provides fluorescent lighting as a much superior type of lighting source in a four-inch, six inch, seven inch, ten inch or any other type or shape of lamp which incandescent lighting has been very prominently used in vehicular and trailer lighting applications worldwide. Now with the use this new retrofit fluorescent type of fluorescent lighting it can now provide a super bright light, which offers a much more visible light than standard incandescent light bulb lighting, which can light up greater area then a standard incandescent bulb lamp and consumes considerably less power then incandescent bulbs lighting and can fit it the same hole and fixture as the standard incandescent lamp which was removed or placed in the standard hole incandescent bulbs are used in vehicle or trailer manufacturing without having to re-tool the product to be able to use this new retro-fit fluorescent lamp.

### BRIEF DESCRIPTION OF THE DRAWINGS

FIG. 1 Shows an example of a 4-inch lamp containing a case 4 with a lens 5 sealed onto case 4. You can see a circuit board 6 is mounted at the bottom of the case 4 with the ballast 2 with all the controller components mounted on the circuit board 6, and above the ballast just under the lens 5 you can see the fluorescent bulb 1. At the back of the case you can see where two wire enters into the case thought the back of the case 4 with a TMI water tight designed bushing 3 to keep out the moisture and water making the lamp water tight.

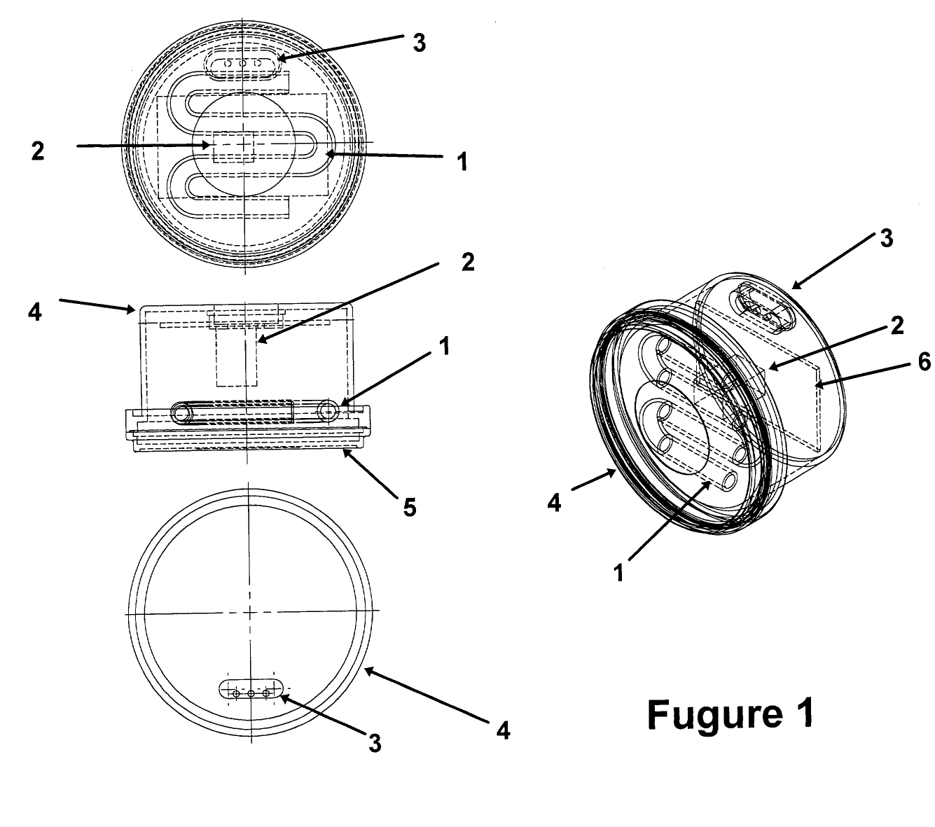

FIG. 2 Shows input voltage +6.5 to 28 VDC to the cut-off sensor 8 and the step-up converter 9, which then feeds the electronic ballast 2 that operates the fluorescent lamp 1 that comes back to electronic ballast 2 then to ground at 10.

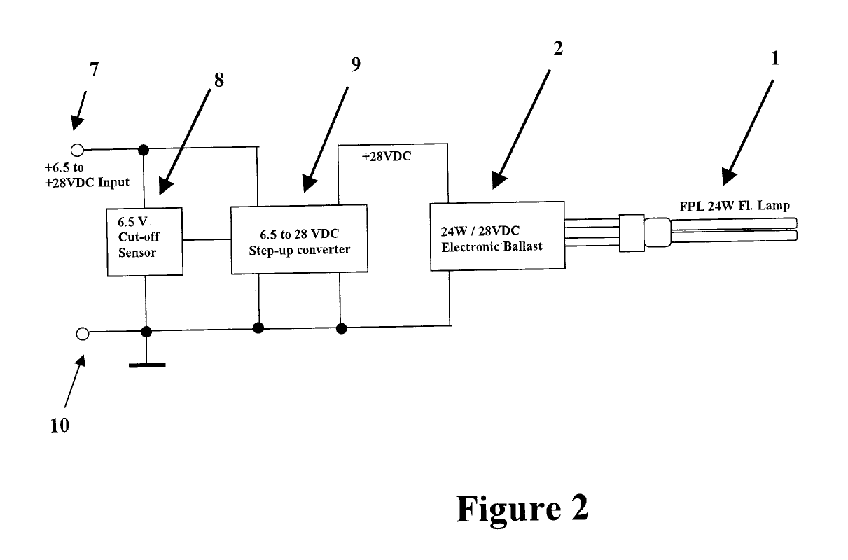

FIG. 3 Show a simple four inch lamp round case 4 that hold pcb 6 where the cut off sensor 8, step-up converter 9 and electronic ballast 2 are mounted thereon pcb 6, which a reflector 12 is mounted over top of all the electronics below to help reflect all heat and all light out through the front lens 5 area.

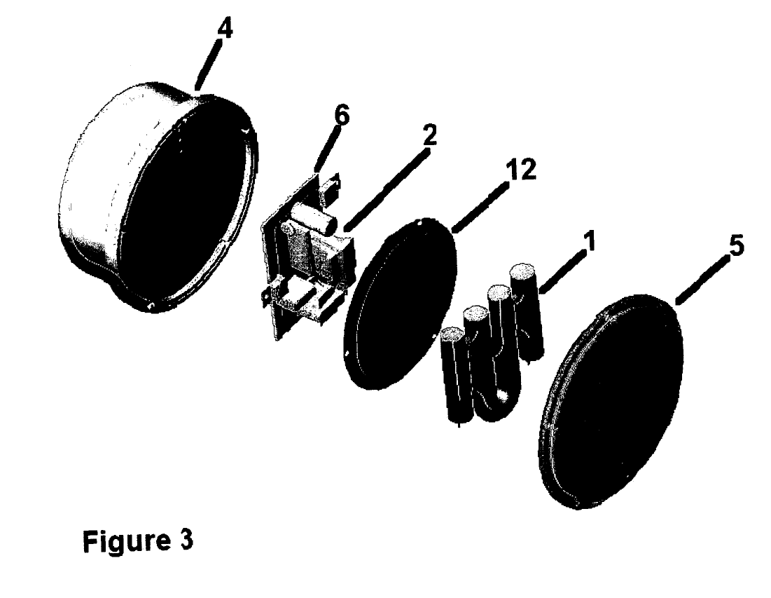

### DETAILED DESCRIPTION OF THE INVENTION

The present invention provides fluorescent lighting as a much superior type of lighting source in a four-inch, six inch, seven inch, ten inch or any other type or shape of lamp which incandescent lighting has been very prominently used in vehicular and trailer lighting applications worldwide. Now with the use this new retrofit fluorescent type of lighting it can now provide a super type of bright light, which offers a much more visible light than most standard incandescent light bulb lighting, which can light up much greater area then standard incandescent bulb lighting and consumes considerably much less power then incandescent bulbs lighting and produces much less heat, which is greatest concerns for those vehicle and trailer applications, where the cities, towns and states are passing new laws regulating delivery trucks to turn off their gasoline or diesel engines when making deliveries for safety reasons and the prevention of air pollution and engine noise to the surrounding communities. One of the biggest features of a retrofit fluorescent light is the mounting fixture does not need to be changes to accommodate the new replacement fluorescent lamp. There are many types of applications both new and old that can use retrofit fluorescent lighting, which can contain a regulated circuit for protecting the circuit and fluorescent bulb from overheating or premature failure in both manufacturing of new vehicles and trailers or as a retrofit in existing type of applications. Fluorescent lamps currently being used in some recreational vehicles do not have any type of regulated circuit protection to protect the ballast or bulb from overheating and premature failures, which over heating can cause fires. When using a regulated circuit it help prevent ballast and fluorescent bulb from overheating from under power or over powering from fluctuating power being produced in DC type of applications in vehicle and trailer applications worldwide. The ballast overpowering or under powering in many fluorescent lamps is the main problems of premature lamp failures in some vehicle applications like in trucks, trailer, motor homes and recreational vehicles of many sizes used on or off the roadways. With the use of regulated circuit, it will automatically regulate the proper power to the fluorescent bulb and can automatically cut off the power when to power goes above the limit or can increase the power to the fluorescent when the power falls below the normal operating power to properly power the lamp it its designed voltage. If the power falls below the normal operating power range the circuit can send out a audible warning signal or by flashing the lamp on and of for a short period of time allowing ample time for a person to be able to exit out of the vehicle or trailer before the lamps shuts down for safety protection of the ballast and fluorescent bulb. The fluorescent lamp can then be restarted when the power is increased back to its normal operating range. The safety circuit can be designed that the power must be turned off and then be turned back on to reset the lamp and if the power is at or above the normal operating or preset range preset into the lamp.

What is claimed:

1. A fluorescent lamp of any size or shape to replace standard incandescent lamps of any type size or shape used in or on any type of non-vehicular and vehicular application including autos, trucks and trailers.

2 A fluorescent lamp, which can contain a safety cut off circuit, self regulated circuit to step up or step down power, which everything can be solid state or non solid state components allowing the lamp to be used in fluctuating DC voltage applications, which can offer an audible or visual or both audible and visual warning to the operator if the voltage falls below or above the preset operating rang which eventually cuts the power to circuit if power does resume the normal preset operating range it was designed to operate at which can include most commonly 12, 24 or 48 voltage applications. The input power can be preset from 0.50 volt and up Now for special DC type of applications, where a special circuit would need to be included to step up the power to be able to power the ballast and fluorescent bulb at it normal designed operating power.

3. A retro-fit fluorescent lamp design, which can copy exactly the same size or shape and design including the case, the lens design and the material of a incandescent lamp, which can mount in the same hole, mounting fixture, brackets of a standard incandescent lamp, which the fluorescent lamp can contain a cut-off sensor step-up or step down converter electronic ballast and fluorescent bulb of any shape or size and brightness inside the case and lens, which the whole lamp can be held together with 1 or more fasteners of any type or shape allowing any of the components of the lamp to be serviceable or replaceable.

4. Fluorescent lamp design which can copy exactly the same size or shape and design including the case, the lens design and the material of a incandescent lamp, which can mount in the same hole, mounting fixture, brackets of a standard incandescent lamp, which can contain a cut-off sensor step-up or step down converter electronic ballast and fluorescent bulb of any shape or size and brightness inside the case and lens, which the whole lamp can be sealed using ultrasonic plastic welding or any other type sealing making the lamp and its parts non replaceable or serviceable, providing a non-replaceable option.
